(19) United States
(12) Patent Application Publication
(10) Pub. No.: US 2017/0177608 A1
(43) Pub. Date: Jun. 22, 2017

(54) ELECTRONIC FILE MANAGEMENT SYSTEM

(71) Applicant: Bank of America Corporation, Charlotte, NC (US)

(72) Inventors: Sorin N. Cismas, Southlake, TX (US); Manu Kurian, Dallas, TX (US); Jerzy Miernik, Allen, TX (US); Paul Roscoe, Treuddyn Flintshire (GB); Saritha Vrittamani, Plano, TX (US); Bradley Tormoen Criqui, Richmond, VA (US); Ramanathan Sankarasubramanian, Coppell, TX (US); Lixian Huang, Plano, TX (US); Qishan Cai, Frisco, TX (US)

(21) Appl. No.: 14/973,019

(22) Filed: Dec. 17, 2015

(51) Int. Cl. G06F 17/30

(52) U.S. Cl. CPC G06F 17/30165; G06F 17/30082; G06F 17/30194

(57) ABSTRACT

An electronic file management system may include an electronic file data repository and a file analysis engine that may include a processor and a non-transitory memory device. The non-transitory memory device may store computer executable instructions that, when executed by the processor, cause the file analysis engine to analyze an electronic file to identify a file identifier and determine whether a matching file has previously been saved in a data repository. If a matching file was found by the file analysis engine, a link to the previously saved file may be saved to the data repository and if not, the electronic file itself may be saved to the data repository. The file analysis engine and/or a permissions engine may analyze file itself and/or the contents of the electronic file to determine one or more permissions levels associated with the electronic file and save the file according to the permissions levels.

### BACKGROUND

A business organization may process large amounts of data (e.g., images, documents, and the like) stored in one or more databases, such as text documents, presentations, images, webpages, communications (e.g., emails, letters, catalogs, and the like), to name a few. In many cases, the data stored in the one or more databases may include private, confidential, or otherwise non-public information. Often, multiply copies of the same file, or multiple files having the same data contents may be repeatedly stored and/or moved within the shared environment of the business organizations computing system. As such, the data storage capacity of the business organization's computing system may necessarily be oversized to account for such redundant data storage. In some cases, a large portion (e.g., about 75 percent) of the business computing system's data storage capacity may be allocated to store such redundant data. Further, the moving and/or storage activities associated with the redundant data may cause the servers of the business computing system to operate at a much higher capacity than would normally be necessary. As such, a need has been recognized for an electronic file management system to better manage file storage and collaboration activities with respect to shared data stored on a computer network.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, an electronic file management system may include at least an electronic file data repository and a file management engine that may include a processor and a non-transitory memory device. The non-transitory memory device may store computer executable instructions that, when executed by the processor, cause the file analysis engine to analyze an electronic file to determine an associated first file identifier, analyze a plurality of records stored in the data repository to determine whether the first file identifier corresponds to a second file identifier associated with a previously saved file, store, on a data storage device, the electronic file as a link to the previously saved second file when the first file identifier corresponds to the second file identifier, store, on the data storage device, the electronic file when the first file identifier is different than the second file identifier of each of the plurality of files, and associate, by a permissions management engine, at least a first permissions level and a second permissions level to the electronic file, wherein the first permissions level corresponds to an access level allowing a first user access to a first portion of the electronic file and the second permissions level corresponds to an access level allowing a second user access to a second portion of the electronic file, wherein the first permissions level is different than the second permissions level.

In some cases a method of managing electronic file access may include analyzing an electronic file to determine an associated first file identifier and analyzing a plurality of records stored in a shared data repository to determine whether the first file identifier corresponds to a second file identifier associated with a previously saved file, storing, in one or more data repositories, the electronic file as a link to the previously saved second file when the first file identifier corresponds to the second file identifier, storing, in one or more data repositories, the electronic file when the first file identifier is different than the second file identifier of each of the plurality of files, receiving, from a permissions management engine, at least a first permissions level and a second permissions level to the electronic file, wherein the first permissions level corresponds to an access level allowing a first user access to a first portion of the electronic file and the second permissions level corresponds to an access level allowing a second user access to a second portion of the electronic file, wherein the first permissions level is different than the second permissions level, analyzing information stored in the electronic file to determine whether non-public information is stored in the electronic file, wherein the non-public information comprises at least private information or confidential information, and storing at least a portion of the electronic file in one or more of a first data repository storing public information, a second data repository storing private information, and a third data repository storing confidential information.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 shows an illustrative electronic file management system, according to one or more aspects of the present disclosure; and

FIG. 2 shows an illustrative method for managing content and/or access to electronic files according to one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

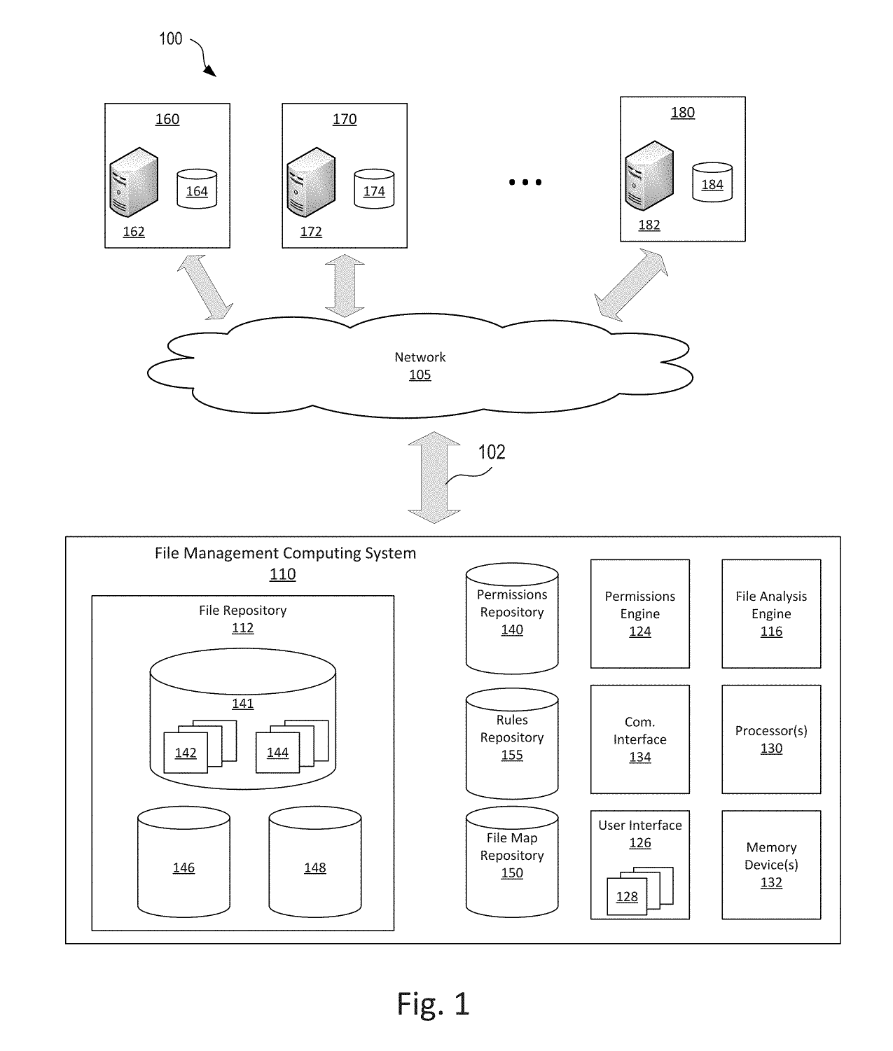

FIG. 1 shows an illustrative electronic file management computing system 110, according to one or more aspects of the present disclosure. The electronic file management computing system 110 may include one or more electronic file repositories 112 that may be used to a plurality of electronic files, where the one or more electronic file repositories 112 may include one or more databases 141, 146, and/or 148. The electronic file management computing system 110 may further include a file analysis engine 116 and a permissions engine for use in analyzing a plurality of electronic files and/or managing permissions for accessing the plurality of electronic files. Additionally, the electronic file management computing system 110 may include a user interface 126, a non-transitory memory device storing one or more user interface screens 128, one or more processors 130, one or more memory devices 132, and/or a communication interface 134, a permissions data repository 140, a rules repository 155, and/or a file map repository 150. The communication interface 135 may facilitate communication between the electronic file management computing system 110 via a network 105 using one or more wired or wireless communication links 102. The electronic file management computing system 110 may communicate, via the one or more wired or wireless communication links 102 over the network 105, with one or more computing systems 160, 170, and 180. The electronic file management computing system 110 may be implemented using a special purpose computing device (or computing devices) that have been specially programmed to perform functionality according to one or more aspects of the present disclosure.

In some cases, the business organization may utilize one or more computing systems in the course of business. For example, one or more of the computing systems 160, 170 and 180 may be associated with one or more business units of the business organization. These computing systems may include one or more computer servers implementing databases and other data storage media that is configured to store data associated with the operations of the business units, such as documents and/or images. For example, the computing systems 160, 170, and 180 may include document databases 164, 174, and 184 storing information (e.g., documents, images, and the like) corresponding to the operations of the corresponding business unit. Such information may be referred to as “documents”. However this term may include such information as text documents, spreadsheets, presentation slide decks, images, communications such as emails, letters, and/or the like. Because the operations of each business unit may differ, the permissions associated with accessing these documents 142 that may be stored in the file repository 112, or locally in the document databases 164, 174, and 184 may also be dependent on one or more business rules, government regulations and/or the like. As such, when data is shared between individuals, either within the same business unit and/or outside of the particular business unit, certain non-public, confidential, and/or private information included in the documents may be required to be controlled to ensure proper access protocols have been followed. For example, the permissions data repository 140 and/or the rules repository 155 may be used to store information, such as business rules, government regulations, and the like, that may be configured to control the access to and/or the dissemination of information that is deemed to be non-public or private according to the operations of the particular business unit. While FIG. 1 shows that the document databases 164, 174, and 184 may be implemented in different computing systems communicably coupled to, and remote from, the electronic file management computing system 110, one or more portions of these rules repository databases may be incorporated into the electronic file management computing system 110.

In an illustrative example, the rules repository 155 (e.g., a database, and the like.) may store computer executable instructions defining and/or classifying information as public information, private or nonpublic information, and/or confidential of the documents 142 that may be stored in the electronic file repository database 141 and/or may be stored in one or more of the data repositories 144, 154, 164. In some cases, these rules may be applied at the creation, editing and/or communication of each of the plurality of electronic files, such as when the documents 142 may be communicated over the network 105 to one or more computing networks internal to the business organization or to one or more computing network external to the business organization (e.g., the external computing system). In some cases, the rules repository database 155 may include computer executable instructions for implementing one or more business rules and/or government regulations for enforcing permissions and/or a location at which such documents are to be saved with regards to certain non-public information. Such non-public information (e.g., private information, confidential information, and the like) may include, but not be limited to, personal identification information, such as names, addresses, phone numbers, social security numbers, employer information, family information (e.g., spouse name, spouse age, a number of children, children's names, children's ages, images of each family members, and the like), demographic information (e.g., an income level, an ethnicity, and the like), health information (e.g., medical records, and the like), age information, personal preference information (e.g., a preferred or trusted method of contacting the individual, and the like), and/or other such information. In some cases, the non-public information may include, but not limited to, financial information, such as credit history information, financial account information (e.g., an account number, an account balance, a financial institution associated with one or more accounts, an account password, and the like), a financial advisor name, direct deposit information, employment information (e.g., an employer name, an employer address, employer phone number, a length of employment, and employment status, and the like). In some cases, the non-public information may include, but not be limited to, the operation of the business, such as business strategy information, a sales lead list, a customer list, a supplier list, pricing lists, inventory information, manufacturing information, an organizational chart, and/or the like.

In some cases, the rules repository database 155 may store computer executable instructions to cause a computing device (e.g., the file analysis engine 116, the permissions engine 124, and the like) to analyze a particular electronic file to ensure that the access to the data and/or the communication of the data may be controlled based on the data itself (e.g., personal information, financial information, business information and/or the like), an intended recipient of the particular electronic file, and/or the source of the particular electronic file. In some cases, the permissions engine 124 may be used to associate and/or check permissions levels associated with one or more users or groups and may manage access (e.g., allow access, restrict access, deny access, and the like) to files by users and/or groups based on the permissions. For example, access to files may include viewing, modifying, loading, saving, printing, sending, and/or other file-related activities. In some cases, a user may be assigned a permissions level for one or more file activities (e.g., view, modify, and the like), and a different permissions level for one or more different file activities (e.g., save, print, send, and the like). For example, a document shared between individuals within a same business unit may have different permissions to view, or otherwise access, the non-public information than an individual in a different business unit of the same business organization, which in turn, may be different than the permissions granted to an individual external to the business organization. In addition, a level of employment may also be taken into account by the business rules stored in the rule repository 155 (e.g., databases). For example, a manager may be allowed to view more or different information (e.g., complete names, complete addresses, partial social security numbers, and/or the like) than a supervisor who, in turn, may have different permissions (e.g., partial names, partial addresses, redacted social security numbers, and the like) than their employees (e.g., names, addresses, and social security numbers are redacted). In some cases, the permissions may differ based on a particular outside organization associated with the particular individual who may receive the particular document. For example, an employee communicating with the Security Exchange Commission (SEC) may have different permissions to certain non-public information that may be included in documents than a different employee who instead may be communicating with the Internal Revenue Service (IRS).

In some cases, the electronic file management computing system 110 may be implemented at a central location and be utilized by one or more different business units and/or business organizations to manage access to information stored and/or communicated in an electronic file. In some cases, at least a portion of the electronic file management computing system 110 may be incorporated into the computing systems associated with a particular business unit (e.g., the computing systems 160, 170, and/or 180). In an illustrative example, an instance of the electronic file management computing system 110 may be incorporated into the computing system 160, while the computing systems 170 and 180 may utilize a remote installation of the electronic file management computing system 110 via the network 105. By doing so, the business organization may enable efficient use of the computing system components and allow for more efficient processing and/or communication of the documents with respect to the system 100.

The electronic file management system computing system 110 may include one or more computing devices that may be communicatively coupled to a network 105. The network 105 may be communicatively coupled to one or more devices, such as to servers, at one or more facilities associated with one or more business units of the business organization and/or one or more organizations (e.g., business organizations, educational institutions, governmental agencies, and the like) external to the business organization. The network 105 may include one or more wired and/or wireless networks, such as a telecommunications network (e.g., a cellular network, a land line network, a cable network, and the like), a Wi-Fi network, a local area network (LAN), a wide area network (WAN), the Internet, and the like.

In the illustrative embodiment of FIG. 1, the electronic file management computing system 110 may include one or more processors (e.g. microprocessor, microcontroller, and the like) 130, one or more memory devices 132, a communication interface 134, one or more inputs and/or output devices (I/O), and a user interface 126. The one or more processors 130 may operate by using an algorithm that facilitates the analysis of one or more electronic documents by computer executable instructions implementing business rules for managing access and/or communication of information associated with the electronic documents. This algorithm may be included as instructions stored in one or more of the memory devices 132 and may be included as a portion of the file analysis engine 116, the permissions engine 124 and/or the like. The one or more processors 130, for example, may operate by receiving an electronic document, or a link to the electronic document, analyzing information associated with the electronic document based one or more rules stored in rules repository databases 155 and/or the permissions repository 140, and providing defined access to the electronic file to an intended recipient.

In an example, the one or more processors 130 may be configured to operate the algorithm and/or the file analysis engine 116 and/or the permissions engine 124 on a special purpose computing device using an operating system (e.g., Windows, OS X, iOS, Android, Linux, Unix, GNU, and the like). In some cases, the memory devices 132 of may be communicatively coupled to the one or more processors 130, such as via a data bus. The one or more memory devices 132 may be used to store any desired information, such as the aforementioned algorithm, a lookup table, computer executable instructions to implement the business rules for redacting and/or tokenizing electronic documents, and/or the like. The one or more memory devices 132 may be any suitable type of storage device including, but not limited to, RAM, ROM, EPROM, flash memory, a hard drive, and the like. In some cases, the one or more processors 130 may store information within the one or more memory devices 132, and may subsequently retrieve the stored information.

In some cases, the electronic file management system 110 may include a communication interface 134 for exchanging data with one or more different computing devices and/or computing systems via a wired and/or wireless link 102. Such data may include electronic documents stored in a data repository database 141, a link to an electronic document stored in the data repository database 141, one or more business rules for analyzing the electronic documents, a link to computer executable instructions stored in the rules repository database 155 for analyzing the electronic documents, recipient information, sender information, and/or the like. The communication interface 134 depicted in FIG. 1 may include an interface to a local area network (LAN) and/or a wide area network (WAN), but may also include other network interfaces. When used in a LAN networking environment, the electronic file management computing system 110 may be connected to the LAN through a network interface or an adapter that may be included as a portion of the communication interface. When used in a WAN networking environment, the electronic file management computing system 110 may include a modem and/or other means for establishing wired and/or wireless communications over the WAN, such as the Internet. It will be appreciated that the network connections discussed are illustrative and other means of establishing a communications link between the electronic file management computing system 110 and the computing systems 160, 170, and 180 may be used. The existence of any of various protocols such as TCP/IP, Ethernet, FTP, HTTP and the like is presumed. In some cases, one or more of the file analysis engine 116, the permissions engine 124 may be optionally hosted remotely from the file analysis engine 116, and the permissions engine 124. In such cases, the electronic file management computing system 110 may be operated in a client-server configuration to permit a user to optionally retrieve web pages from a web-based server.

In some cases, the electronic file management computing system 110 may include other inputs and/or outputs (I/O). The I/O may include a data port (e.g., a wireless port) that may be configured for communication using a protocol, such as a Bluetooth, Wi-Fi 33, ZigBee or any other wireless protocol. In other cases, data port may be a wired port such as a serial port, an ARCNET port, a parallel port, a serial port, a CATS port, a USB (universal serial bus) port, and/or the like. In some cases, the data port of the I/O may use one or more communication protocols, such as Ethernet, and the like, that may be used via a wired network or a wireless network. In some instances, the I/O may include a USB port and may be used to download and/or upload information from a USB flash drive or some other data source. Other remote devices may also be employed, as desired.

The I/O may be configured to communicate with the one or more processors 130 and may, if desired, be used to upload information for use by the one or more processors 130 and/or download information from the one or more processors 130. Information that can be uploaded and/or downloaded may include, for example, values of operating parameters, configurations, business rules, documents, lookup tables, and the like. In some instances, the I/O may be used to upload a previously-created documents, and/or computer executable instructions for implementing one or more business rules for use in managing access to the document information thereby hastening electronic file management process. In some cases, the I/O may be used to download data stored within the memory devices 132. For example, the I/O may be used to download a redacted or tokenized document as generated by the electronic file management computing system 110. The generated managed files and/or documents, or other information may be downloaded to a device such as a USB memory stick (also sometimes referred to as a thumb drive or jump drive), a personal computer, laptop, tablet computer, a PDA, a smart phone, or other device, as desired. In some cases, the data may optionally be convertible to a spreadsheet format, a text document format, plain text format, an XML file, and/or published document format file.

In the illustrative embodiment of FIG. 1 the user interface 126 may be a user interface device that permits the electronic file management computing system 110 to display and/or solicit information, as well as accept one or more user interactions with a user. For example, the user interface 126 may permit a user to enter data that may be permission restricted in a document and/or data that may be used in place of text in the electronic document (e.g., an electronic image, and the like). In some cases, the user interface 126 may include a display and a distinct keypad. In some cases, the user interface 126 may include a display and a virtual keypad. A display may be any suitable display. In some instances, the display may include or may be a liquid crystal display (LCD), and in some cases a fixed segment display or a dot matrix LCD display. If desired, user interface 126 may be a touch screen LCD panel that functions as both display and keypad. In some instances, a touch screen LCD panel may be adapted to solicit information from a user and/or to receive such information. The user interface 126 may be adapted to display one or more user interface screens 128. For example, the electronic file management system may include a computing system 110 may be configured to solicit and/or present information to a user via the one or more use interface screens 128, such as by displaying a proposed redacted and/or tokenized document for review, displaying an alert regarding an error generated during the tokenization and/or redaction process, and/or the like.

In many cases, the electronic file management computing system 110 may be used to monitor the storage, access, and/or communication of a plurality of electronic documents to ensure proper data handling of non-public information. In some cases, electronic documents may be shared and/or stored on the network by many people, and often may be stored multiple times by the same user. Because of this, the operations of the business organization's computing systems may be slow or sluggish due to a large amount of redundant data being stored and/or communicated. For example, a user may forget that a copy of the document has already been saved onto the computing system, and store one or more additional copies of the same electronic document. As such, the data storage requirements of a business organization may be increased due to the additional requirements due to the redundant data stored on the network. Further, communication of this redundant data may slow down the operation of the network. By controlling the access to and/or storage of the electronic files, business organizations may be able to reduce costs associated with storing electronic files and/or improve network performance. In an illustrative example, data headers (e.g., file headers), or other identifying information (e.g., metadata, file data, and the like) may be used to track electronic files and the information stored within the files to store only one electronic file with the same and/or similar data content across the business network. Computer executable instructions may be used to control access to the information stored in the electronic file repositories 141, 146, and/or 148.

In some cases, the file analysis engine 116 may process computer executable instructions stored in the one or more memory devices 132 to analyze an electronic file to determine an associated first file identifier and, in turn, analyze a plurality of records stored in a shared data repository to determine whether the first file identifier corresponds to a second file identifier associated with a previously saved file. The file analysis engine 116 may store the electronic file in one or more data repositories such as the file repository 141 as a link to the previously saved second file when the first file identifier corresponds to the second file identifier. In other words, when the file analysis engine 116 identifies an electronic file 142 stored in the data repository has a same file identifier (e.g., one or more of a data header, a file name, a file creation date, a file save date, a last access date, and/or the like) as an electronic file to be stored, the file analysis engine 116 may store the new electronic file as a link to the original electronic file 142. Further, the file analysis engine 116 may further process instructions to alert a user that a same, or similar, file has already been created in the data repository. In doing so, the file analysis engine 116 may present this information via a user interface screen 128 via the user interface device 126 and may prompt the user for permission to save the file as a link. In some cases, when the first file identifier associated with the new electronic file to be saved is different than the file identifiers associated with the previously saved electronic files 142 stored in the data repository 141, the new electronic file is stored in the file repository 141.

Further, the file analysis engine 116 may process instructions to associate one or more access levels to the stored electronic file 142 based on information received from the permissions engine 124. For example, the file analysis engine 116 may receive from the permissions engine 124 one or more permission levels that may be applied to the stored electronic file. For example, a first permissions level may correspond to an access level allowing a first user access to a first portion of the electronic file and a second permissions level may correspond to an access level allowing a second user access to a second portion of the electronic file, wherein the first permissions level is different than the second permissions level. The file analysis engine 116 may further analyze information stored in the electronic file 142 to determine whether non-public information is stored in the electronic file, wherein the non-public information comprises at least private information and/or confidential information. The file analysis engine 116 may then store at least a portion of the electronic file in one or more of a public information data repository (e.g., the data repository 141 and the like), a second data repository (e.g., a private information data repository 146 and the like), and/or a third data repository for storing confidential information (e.g., the confidential information data repository 148 and the like) based on the analysis of the electronic file information.

In some cases, the file analysis engine 116 may generate one or more “labels” that may be associated with electronic files, such as by saving the labels as metadata associated with each electronic file. For example, these labels may be associated with a data content type (e.g., public information, private information, confidential information, and/or the like). In some cases, the labels may be associated with a topic of the electronic file, keywords included in the electronic file and/or the like. In using these labels, the electronic files may be stored more efficiently in the electronic file repository 112 and searches for same or similar electronic files may also be performed more efficiently. In some cases, the labels may be applied to one or more “file maps” stored in the file map repository 150 that may be used to manage storage of original electronic files and/or one or more other electronic files that may include additional content of a modified version of the electronic file, as discussed below.

In some cases, the permissions engine 124 may be used to manage access to the electronic files stored in the file repository 112. For example, the permissions engine may implement a permission scheme for allowing an electronic file to be stored as a single file or as multiple files stored in different locations. This permissions scheme may be based upon one or more business or governmental rules stored in the rules repository 155 and/or may be saved in the permissions repository 140. The permissions engine 124 may also process instructions stored in the memory devices 132 that cause the permissions engine 124 to identify a user attempting to store or access an electronic file and to determine a portion of the electronic files the user is permitted to access. For example, the permissions repository 140 may include a listing of users where each user is associated with one or more access levels to data stored in the file repository 112. In an illustrative example, a first user may be granted access only to public information, while a second user may be granted access to private information and public information, a third user may be granted access to public information and confidential information and a fourth user may be granted access to all public, private, confidential and non-public information. In some cases, the user permissions may be associated with group access permissions. For example, an employee user group may be granted access to public information, a supervisor group may be granted access to public information and private information, a compliance user group may be granted access to confidential information, and a management group (e.g., senior management) may be granted access to all public information, confidential information, and non-public information. In some cases, the permissions may be associated with a work function and may vary based on a particular document. For example, a user may be granted public access to an electronic file corresponding to a first topic (e.g., governmental compliance, and the like), and may be granted access to private information in a second electronic file (e.g., employee identification information). These permissions may be stored in the permissions repository and accessed, as needed, by the file analysis engine. The rules repository 155 may include one or more governmental, regulatory, and/or business rules, as discussed above, and may likewise be accessed by the file analysis engine and/or the permissions engine in determining access levels for individual users and/or groups of users.

In some cases, the file analysis engine 116 may be configured to allow audit tracking of electronic files that may allow modified documents to be version controlled. Unlike many collaboration tools, the electronic file management computing system 110 may allow a same electronic file (e.g., a document, a presentation slide deck, and the like) to be modified, and tracked, based on each individual user's needs. For example, an electronic file may be modified to include information associated with a particular user (e.g., lines 20-30) that would not be useful for the original owner of the document. As such, and rather than generating a new document, the changes may be saved as a difference file (e.g., a delta change), where the combination of the original file and the difference file may be combined to form the second version of the document. Such versioning may be managed by the file analysis engine by generating a file map corresponding to the particular electronic file which may be stored in the file map repository. The file map may be used to store information about one or more different versions of the same document and/or the user(s) that may be associated with each of the different versions. In some cases, the file map may be generated as a list, as a tree, as a data structure, and/or the like. For example, the file map may include entries such as: original file:public:user1; version1,original,delta_file1:public:user2,group1; version2,original,delta_file2: public,confidential:user3. In this illustrative example, three versions exist in the file repository, the original file, the first version (e.g., version1), and the second version (e.g., version2) where the first version includes the original file and the changes made by user2 and stored in delta_file1 and the second version includes the original file and the changes made by user3 and stored in delta_file2. The original file and the delta files may be stored in the electronic file repository 112 in one or more databases. In some cases, the original file may be stored as a complete document, such as the document files 142, and the delta files may be stored as delta files, such as the change files 144 (e.g., delta files). The change files 144 may be stored as a file only including the changes made by a user to an original document. In some cases, the change files may include the changes and a reference (e.g., a line number, a character number, a page number, a hyperlink, and the like) to a position in the original file at which the changes were made. For example, a delta file may include the changes made to the particular original file, and one or both of a reference to the original file and a reference to a position in the original file. In some cases, the reference file may include additional text near the position of the original document in which the changes had been made. In such cases, the delta changes are presented to a user in context of at least that portion of the original file. In some cases, the delta changes may be presented merely as the changes and any references to the original document may be listed in an associated file map. In some cases, the version documents (e.g., version1, version2, and the like) may be stored as a “complete” file including the original file and the incorporated changes (e.g., the ‘delta’). In some cases, the electronic file may include permissions information, version information, and/or location of changes per version in a file map, metadata associated with one or more files, or a combination.

In an example, the changes (e.g., the delta) made to the electronic file (e.g., the original file, a versioned file, a delta file, and the like) may be stored as separate files, such as the change files 144. In some cases, the changes made in the delta file may be used by only the author of the changes, by users who are members of a same or related group (e.g., supervisors, managers, and the like) of the author of the changes, or by other individuals, such as the author of the original file. In an illustrative example, a user may generate an original electronic document for use by the business unit, where the original electronic document includes lines 1-10. A second user may revise that original electronic document by adding lines 11-20, but the originating first user does not need these changes, or have permission to view the changes. As such, the file analysis engine 116 may generate a delta file containing lines 11-20, having permissions for at least the first user, but not necessarily permissions for the first user. In situations like this, existing version management software packages may integrate the changes into a final version, where any use of a previous version would need to be consciously chosen by the user. Here, the permissions set up by the permissions engine 124, the file map stored in the file map repository 150, and the delta file 144, the each user may automatically access their desired version of the document without additional configuration and/or selection.

In some cases, an original electronic document may be configured to include different permissions for different sections of the electronic document. In an illustrative example, an employee of a business organization may generate a document for a client (e.g., a contract), where different sections of the contract may not necessarily need to be seen by others working on the document. In such cases, a first portion of the contract may be given read/write permissions for a first group, a second portion of the contract may be given read/write permissions for a second person, and a third portion of the contract may be given read/write permissions to a third group and read only permissions to a fourth group. A fifth group (e.g., a senior management team, a legal team, and the like) may be given read/write permissions for the complete electronic document. In such cases, only individuals who have a need to know the complete electronic document may be granted access to the complete document. In doing so, inadvertent data leakage events may be avoided, or at least minimized in frequency. In some cases, the electronic document may be stored in the file repository as a complete original file 142 having multiple permissions defined for different sections of the document, as an original file 142 that may be linked to one or more different delta files 144 using a file map stored in the file map repository 150. In some cases, the file map may be stored as a text-based outline file including hyperlinks to the different documents, as a file including pointers to one or more of the files 142 and delta files 144, as an XML file, as an HTML file, or the like. The file analysis engine 116, or another component such as a file manager (not shown) may manage the delta file to track the documents belonging to the same master document and the permissions belonging to each section. In some cases, the master document may obscure or otherwise remove from view, any parent/child sections by removing sections in a generated file made available for viewing by the user or by generating a new document for viewing by a particular user based on the permissions assigned to them. In doing so, the electronic file management computing system may allow for easier sharing of work and/or other collaboration between business teams, while minimizing generation of redundant data being stored on the network. In some cases, the file analysis engine 116 may perform a textual analysis, a graphical analysis, and/or a binary analysis of the electronic file to determine whether similar changes were made to the same electronic document by individuals having different permissions. If so, the file analysis engine may generate an alert to notify individuals, such as via a message (e.g., an email, a text message, an instant message, and the like) and/or a user interface screen (e.g., a pop-up window, and the like) where the user may be presented options for determining whether to include the changes with each group individually, in a common delta file, or in the original document. In other cases, the file analysis engine 116 may process instructions stored in the rules repository 155 to address such a situation, and then one or more users may be notified of the result.

In some cases, the permissions associated with a file and/or portions of the file may include one or more restrictions in an access level to the file for one or more different users or groups of users. Such restrictions may include restrictions on accessing a file or portions of a file, modifying a file or portions of a file, saving a file or portions of a file, sending (e.g., email, text messaging, and the like) a file or portions of the file, printing a file or portions of a file, using print-screen functionality when viewing a file or portions of a file, viewing a file source page or portions of the file source page when viewed in a web browser, creating a local copy of a file or portions of a file, restrict a destination to send a file or portions of a file, and/or the like. In some cases, programs used to access a file may have one or more functionalities disabled based on the permissions granted (or denied) to a user. For example, some software programs (e.g., word processors, spreadsheet editors, presentation slide deck editors, and the like) may include functionality to create a local back-up copy of the file while the file is being viewed or edited by a user. In such cases, the permissions engine 118 may disable this functionality for a file or portion of the file based on permissions granted or denied to the user. In some cases, the permissions engine 118 may enable one or more other restrictions on a user's access to a file. For example, the permissions engine 118 may generate one or more restrictions corresponding to a time of access of a file. For example, the permissions granted or denied by the permissions engine to a user or group of user may include a restriction on when (e.g., a period of time) when a file may be accessed. For example, a first user or group of users may be allowed to access a file at any time, while a second user or group of users may be allowed access to the file within a specified time period, or denied access to the file within a specified time period. For example, a user or group of users may only be allowed access to a file when access is being requested during normal working hours (e.g., about 8 AM to about 5 PM) and/or during other specified time periods (e.g., about 1 PM to about 3 PM, and the like). In some cases, the time period may correspond to a calendar day or a specified number of calendar days. For example, access may be permitted or denied for a time period of a day, a week, a month, and/or the like. In some cases, file access may be permitted (or denied) until a particular time and/or date has been reached. Similarly, the permissions engine 118 may further grant permissions based on a particular device being used based on a name of a computing device, an identifier (e.g., a MAC address of the computing device, and the like), and/or a network location from which access is being requested. For example, the permissions engine 118 may allow or deny access to a file or portions of the file when a particular computing device is attempting to access the file or portions of the file. Further, the permissions engine 118 may allow or deny access to a file or portions of the file when a computing device is attempting to access the file or portions of the file from a particular network location (e.g., a server name, an access path, an outside network connection, and the like).

In some cases the delta files may not be needed. For example, a document may have a short life span (e.g., less than 1 year, less than 1 month, and the like), where edits may be managed in a single document, where the permissions can be granted for the life span of the document, or at least a portion of the life span of the document. As such, the responsible parties would be able to access the documents while needed, but when the document has expired, any further access by the users may be controlled or canceled, as needed. Other document types may not generate a delta file upon edits, such a mission critical document, a low-latency document, and/or the like

In some cases, the file analysis engine 116 may monitor files when moved on the network to manage the moving of redundant data. In such cases, a file access command may be captured by the file analysis engine to determine whether the user is attempting to edit, read, save the document, or the like. When a move or save command has been identified, the file analysis engine 116 may determine whether a new version is to be generated. If not, a link to the original file may be generated rather than generating unnecessary network traffic when copying a redundant file. In some cases, the electronic file management computing system may generate a checksum associated with each document, such as the electronic file 142 and/or the change file 144. By monitoring the checksums of the documents (e.g., the electronic file 142, the change file 144, and the like), the file analysis engine may identify an attempt to save or modify the document. In such cases, the file analysis engine 116, or other component of the electronic file management computing system, may be configured to save the document as a link to the existing file and generate an alert to one or more users of the electronic document that a link to the file has been created and/or indicate a location at which the link had been created.

In some cases, the electronic file management computing system 110 may process instructions stored in the memory device 132 to monitor information stored in the electronic documents 142. The instructions may cause the file analysis engine 116, or other component, to analyze information stored in the electronic files 142, the change files 144 and identify information (e.g., a social security number, a national insurance number, an account number, a postal address, a phone number, a name, a credit card number, health insurance information, and/or the like) that may be restricted from public view. Each section of the electronic file may be configured to be associated with one or more permission levels. The file analysis engine 116 may generate an alert to one or more users, such as by using a message or a user interface screen 128, as discussed above. In other cases, the file analysis engine 116 may assign a new permission level, or further partition the document to include a new section having the new permission level. In such cases, the electronic file, or portions thereof, may be stored in one or more data silos associated with a particular data access level. For example, a first data silo (e.g., data repository 141, or the like) may be associated with a first data access level (e.g., public information), a second data silo (e.g., data repository 146) may be associated with a second data access level (e.g., private information), and a third data access level may be associated with a third data access level (e.g., data repository 148) and the data file, or portions thereof, may be stored in one or more of the data repositories 141, 146, and 148 based on the nature of the data to be stored.

In some cases, the electronic file management computing system 110 may be configured to monitor an age of a file, along with one or more rules (e.g., the rules stored in the rules repository 155) defining a data retention policy regarding the information stored in the file repository 112. In such cases, individuals who need access to such data continue to enjoy access to the data within, for example, a specified time period (e.g., about an hour, about 15 minutes, or the like). Once the illustrative time period has expired, the electronic file management computing system 110 may automatically purge the document from the electronic file management computing system 110. In some cases, an alert may be generated to ensure that one or more users who are allowed to access the file are notified that the file had been identified as being ready for deletion. In doing so, the electronic file management computing system allows for a more efficient use of memory resources.

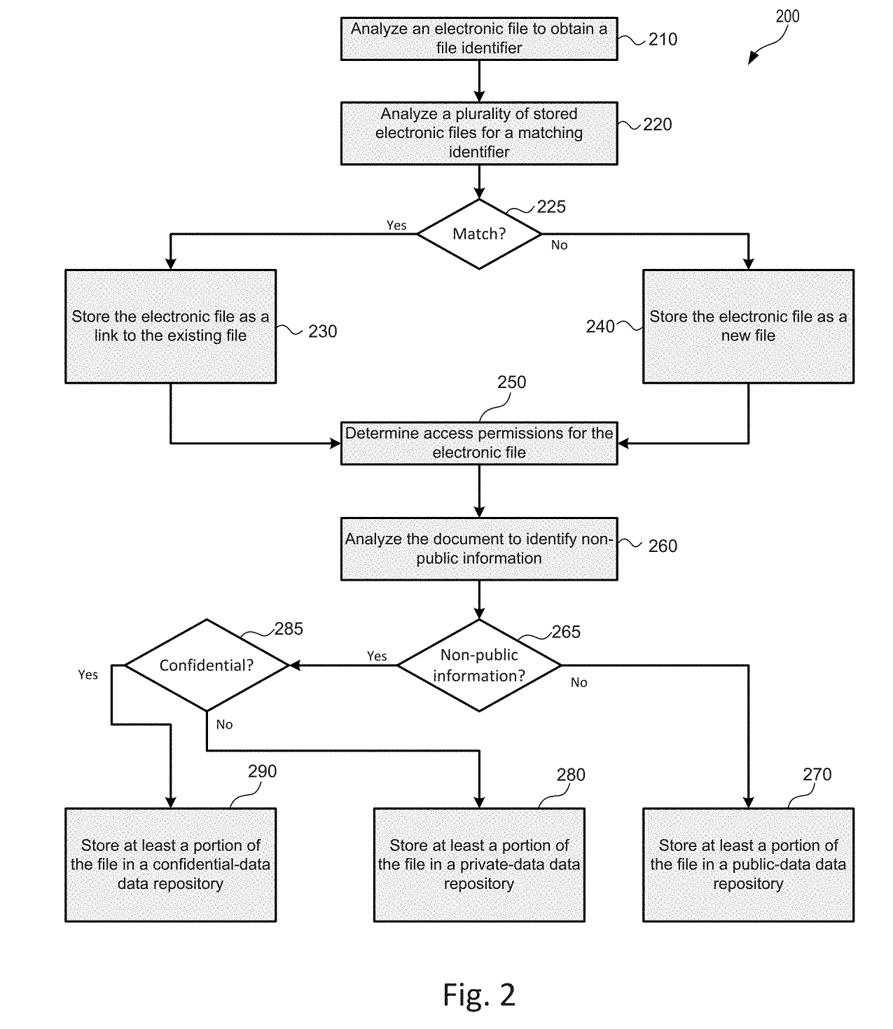

FIG. 2 shows an illustrative method 200 for managing content and/or access to electronic files according to one or more aspects of the present disclosure. At 210, the file analysis engine 116 may be configure to process computer readable instruction stored in the non-transitory memory device 132 to analyze an electronic file to determine an associated first file identifier. In some cases, the electronic file was received via the network 105 from a user computing system, such as the computing systems 160, 170 and/or 180. The electronic file may include information to be stored on the network and may include one or more of public information, private information, confidential information and/or the like. At 220, the file analysis engine 116 may analyze a plurality of records stored in a shared data repository to determine whether the first file identifier obtained from the electronic file matches at least a second identifier associated with a previously save electronic file. In some cases, file identifiers may include a checksum, a file header, a user ID, a save date, a create date, an edit date, and/or a combination of this or like information (e.g., electronic file metadata). At 225, the file analysis engine 116 may determine whether the identifier of the electronic file matches any file identifier of associated with the files stored in the data repository 112 (e.g., the repositories 141, 146, 148, and the like). In some cases, the file analysis engine 116 may generate an alert when a match has been detected, while in other cases, no alert may be generated. If so, the file analysis engine 116 may store a link to the previously saved file, at 230 and may associate the link with a new label (e.g., “File_B”) where the original file may have an associated label (e.g., “File_A”). In some cases, the label associated with the file may be a name given to the file being saved by the user. In some cases, the link may be saved at a location specified by the user. The system may provide notification to the user that a link to the existing file has been saved instead of saving another copy of the original file. In other cases, the system may save the link at the memory location (e.g., folder, directory, and the like) specified by the user as the location to save the file and not provide an indication that a link has been saved rather than another copy of the file. If not, the file analysis engine 116 may store the electronic file in the file repository 112 and may associate the file with a new label (e.g., “File_C”), at 240.

At 250, the file analysis engine 116 may receive from a permissions management engine, at least a first permissions level and a second permissions level to information stored in the electronic file. In some cases, the first permissions level may correspond to an access level allowing a first user access to a first portion of the electronic file and the second permissions level may correspond to an access level allowing a second user access to a second portion of the electronic file. The first permissions level may be different than the second permissions level. At 260, the permissions engine 124 may analyze the electronic file to identify at least a section containing public information and a section containing non-public information. In an illustrative example, the non-public information may include at least private information (e.g., a phone number, an address, a credit card number, and the like) or confidential information (e.g., a medical record, a financial account number, a social security number, and the like). At 265, if non-public information is not found and/or if public information is found, at least a portion of the electronic file is stored in a public-data data repository, such as the data repository 141. If not, then at 265, the file analysis engine determines whether confidential or otherwise non-private information is included in the file. If so, at 290, the file analysis engine may store at least a portion in a confidential-data data repository 148 and/or if the electronic file is determined to include private information, then at least a portion of the electronic file is stored in a private-data data repository 146.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. For example, a computer-readable medium storing instructions to cause a processor to perform methods in accordance with aspects of the disclosure is contemplated.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the present disclosure. The description is thus to be regarded as illustrative instead of restrictive on the present disclosure.

What is claimed is:

1. An electronic file management system comprising:
an electronic file data repository;
a file analysis engine comprising a processor and a non-transitory memory device, the non-transitory memory device storing computer executable instructions that, when executed by the processor, cause the file analysis engine to:
analyze an electronic file to determine an associated first file identifier;
analyze a plurality of records stored in the data repository to determine whether the first file identifier corresponds to a second file identifier associated with a previously saved file;
store, on a data storage device, the electronic file as a link to the previously saved file when the first file identifier corresponds to the second file identifier;
store, on the data storage device, the electronic file when the first file identifier is different than the second file identifier of each of the plurality of records; and
associate, by a permissions management engine, at least a first permissions level and a second permissions level to the electronic file, wherein the first permissions level corresponds to an access level allowing a first user access to a first portion of the electronic file and the second permissions level corresponds to an access level allowing a second user access to a second portion of the electronic file, wherein the first permissions level is different than the second permissions level.

2. The file management system of claim 1, wherein the instructions, when executed by the processor, cause the file analysis engine to:
identify the first file identifier by analyzing a file header associated with the electronic file.

3. The file management system of claim 1, wherein the instructions, when executed by the processor, cause the file analysis engine to:
identify the first file identifier by analyzing the contents of the electronic file, wherein the contents of the electronic file comprises at least one of text data or image data.

4. The file management system of claim 1, wherein the first permissions level allows the first user to edit at least the first portion of the electronic file while excluding access to the first portion of the electronic file to the second user.

5. The file management system of claim 1, wherein the second permissions level allows the second user to edit at least the second portion of the electronic file while excluding access to the second portion of the electronic file to the first user.

6. The file management system of claim 1, wherein the instructions, when executed by the processor, cause the file analysis engine to:
associate, by a permissions management engine, a third permissions level to the electronic file, wherein the third permissions level corresponds to an access level allowing a third user full access to the electronic file.

7. The file management system of claim 6, wherein the first portion of the electronic file comprises at least a section of the electronic file as originally stored in the electronic file data repository and the second portion of the electronic file comprises additional information included in the electronic file after the original file had been stored in the electronic file data repository.

8. The file management system of claim 1, wherein the instructions, when executed by the processor, cause the file analysis engine to:
generate a master document that identifies a relationship between the first portion of the electronic file and the second portion of the electronic file.

9. The file management system of claim 1, wherein the instructions, when executed by the processor, cause the file analysis engine to:
analyze information stored in the electronic file to determine whether non-public information is stored in the electronic file, wherein the non-public information comprises at least private information or confidential information; and
store at least a portion of the electronic file in one or more of a first data repository storing public information, a second data repository storing private information, and a third data repository storing confidential information.

10. The file management system of claim 9, wherein the instructions that cause the file analysis engine to analyze information stored in the electronic file to determine whether non-public information is stored in the electronic file further cause the file analysis engine to analyze a format in which the data is presented in the electronic file, wherein the format corresponds to at least one of a social security number, a national insurance number, an account number, and a mathematical formula.

11. The file management system of claim 1, wherein the instructions, when executed by the processor, cause the file analysis engine to:
generate a checksum based on the information stored in the electronic file; and
monitor a plurality of files being communicated over a network to determine whether a checksum of each of the plurality of files match the checksum of the electronic file; and
generate, when a checksum match has been identified, an alert to a user associated with the electronic file that a copy of the electronic file has been created.

12. A file analysis engine comprising:
a processor; and
a non-transitory memory device, the non-transitory memory device storing computer executable instructions that, when executed by the processor, cause the file analysis engine to:
analyze an electronic file to determine an associated first file identifier;
analyze a plurality of records stored in a shared data repository to determine whether the first file identifier corresponds to a second file identifier associated with a previously saved file;
store, in one or more data repositories, the electronic file as a link to the previously saved file when the first file identifier corresponds to the second file identifier;
store, in one or more data repositories, the electronic file when the first file identifier is different than the second file identifier of each of the plurality of records; and
receive, from a permissions management engine, at least a first permissions level and a second permissions level to the electronic file, wherein the first permissions level corresponds to an access level allowing a first user access to a first portion of the electronic file and the second permissions level corresponds to an access level allowing a second user access to a second portion of the electronic file, wherein the first permissions level is different than the second permissions level.

13. The file analysis engine of claim 12, wherein the instructions, when executed by the processor, cause the file analysis engine to:
identify the first file identifier by analyzing a file header associated with the electronic file.

14. The file analysis engine of claim 12, wherein the instructions, when executed by the processor, cause the file analysis engine to:
identify the first file identifier by analyzing the contents of the electronic file, wherein the contents of the electronic file comprises at least one of text data or image data.

15. The file analysis engine of claim 12, wherein the first permissions level allows the first user to edit at least the first portion of the electronic file while excluding access to the first portion of the electronic file to the second user.

16. The file analysis engine of claim 12, wherein the second permissions level allows the second user to edit at least the second portion of the electronic file while excluding access to the second portion of the electronic file to the first user.

17. The file analysis engine of claim 12, wherein the instructions, when executed by the processor, cause the file analysis engine to:
receive, from a permissions management engine, a third permissions level to the electronic file, wherein the third permissions level corresponds to an access level allowing a third user full access to the electronic file.

18. The file analysis engine of claim 17, wherein first portion of the electronic file comprises at least a portion of the electronic file as originally stored in an electronic file data repository and the second portion of the electronic file comprises additional information included in the electronic file after the original file had been stored in the electronic file data repository.

19. The file analysis engine of claim 17, wherein the instructions, when executed by the processor, cause the file analysis engine to:
generate a master document that identifies a relationship between the first portion of the electronic file and the second portion of the electronic file.

20. A method of managing electronic file access comprising:
analyzing an electronic file to determine an associated first file identifier;
analyzing a plurality of records stored in a shared data repository to determine whether the first file identifier corresponds to a second file identifier associated with a previously saved file;
storing, in one or more data repositories, the electronic file as a link to the previously saved file when the first file identifier corresponds to the second file identifier;
storing, in one or more data repositories, the electronic file in the shared data repository when the first file identifier is different than the second file identifier of each of the plurality of files;
receiving, from a permissions management engine, at least a first permissions level and a second permissions level to the electronic file, wherein the first permissions level corresponds to an access level allowing a first user access to a first portion of the electronic file and the second permissions level corresponds to an access level allowing a second user access to a second portion of the electronic file, wherein the first permissions level is different than the second permissions level.
analyzing information stored in the electronic file to determine whether non-public information is stored in the electronic file, wherein the non-public information comprises at least private information or confidential information; and
storing at least a portion of the electronic file in one or more of a first data repository storing public information, a second data repository storing private information, and a third data repository storing confidential information.
